(19) United States
(12) Patent Application Publication
(10) Pub. No.: US 2010/0120271 A1
(43) Pub. Date: May 13, 2010

(54) IC SOCKET HAVING IMPROVED CONTACT

(75) Inventor: WEI-CHIH LIN, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/616,019

(22) Filed: Nov. 10, 2009

(30) Foreign Application Priority Data
Nov. 10, 2008 (TW) 97220124

(51) Int. Cl. H01R 12/00

(52) U.S. Cl. 439/70

(57) ABSTRACT

An IC socket, adapted for electrically connecting an IC package to a printed circuit board, comprises a main body defining a plurality of passageways and a plurality of contacts received in the passageways of the main body. Each contact has a base portion, a first contacting portion and a second contacting portion extending upwardly from the base portion. The first contacting portion and the second contacting portion each is formed with a contacting end to cooperatively clamp a guiding trace of the IC package. The contacting end of the second contacting portion defines a recess to receive the contacting end of the first contacting portion when the IC package is disassembled to the main body.

### BACKGROUND OF THE INVENTION

1. Field of the Invention

The present invention relates to a test socket, and more particularly to a test socket with improved contact terminal having a stationary end portion and a moveable end portion interlocked to a recessed portion of the stationary end portion to prevent interactively friction therebetween.

2. Description of the Prior Art

Generally, integrated circuit (IC) packages field application or mounted onto a printed circuit board to ensure they are acceptable and meets the design norminals. The test device is usually called IC socket. The IC socket typically comprises a base to receive the IC package, a plurality of contacts received in the base, and a driving cover to establish electrical connections between the IC package and the contacts.

Taiwanese Invention Pat. No. 461150 and 565972 each disclose an IC socket, which includes a base, a plurality of contacts, and a driving cover mounted on the base and being moveable in a vertical direction relative to the base. The contact generally comprises one mating point or dual-mating points. The contact with dual-mating points has a retention portion received in the base and extending upwardly, a first arm and a second arm extending from the retention portion to mate with the IC package.

When the driving cover is depressed to move downwardly and exerts an external force to the contact, the free ends of the first arm and the second arm are separated, at this time, the IC package is set upon a top surface of the base. When the driving cover resumes to original position, the IC package is clamped by the first arms and the second arms, so the IC package is electrically connected with the IC socket. After taking out the IC package, the contact returns back to the original position, and the free end of the second arm is located on a top end of the first arm. The problem is that the free end of the second arm may move and scrap relative to the first arm, and there is a friction between the first arm and the second arm, so that the first and the second arms will deform or damage that may influence the electrical connection of the IC socket. In addition, during an operational process of the IC socket, golden layers of the first and the second arms may be worn and torn off, that also affects the electrical connection of the IC socket.

Therefore, it is need to find a new IC socket having an improved contact to overcome the problems mentioned above.

### SUMMARY OF THE INVENTION

Accordingly, an object of the present invention is to provide an IC socket with an improved contact which is configured with a first contacting portion capable of positioning a second contacting portion.

In order to achieve the object set forth, an IC socket comprises a main body defining a plurality of passageways and a plurality of contacts received in the passageways of the main body. Each contact has a base portion, a first contacting portion and a second contacting portion extending upwardly from the base portion. The first contacting portion and the second contacting portion each is formed with a contacting end facing to each other. One of the contacting ends has a recess to position the other contacting end.

In order to further achieve the object set forth, an IC socket, adapted for electrically connecting an IC package to a printed circuit board, comprises a main body defining a plurality of passageways and a plurality of contacts received in the passageways of the main body. Each contact has a base portion, a first contacting portion and a second contacting portion extending upwardly from the base portion. The first contacting portion and the second contacting portion each is formed with a contacting end to cooperatively clamp a guiding trace of the IC package. The contacting end of the second contacting portion defines a recess to interlock the contacting end of the first contacting portion when the IC package is disassembled to the main body.

### BRIEF DESCRIPTION OF THE DRAWINGS

FIG. 1 is an assembled perspective view of an IC socket according to the present invention;

FIG. 2 is an exposed perspective view of the IC socket of FIG. 1;

FIG. 3 is a perspective view of a contact of the IC socket;

FIG. 4 is a cross-section view taken along line 4-4 of FIG. 1; and

FIG. 5 is another cross-section view taken along line 4-4 of FIG. 1 with an IC package therein.

### DESCRIPTION OF PREFERRED EMBODIMENT

Reference will now be made to the drawings to describe the present invention in detail.

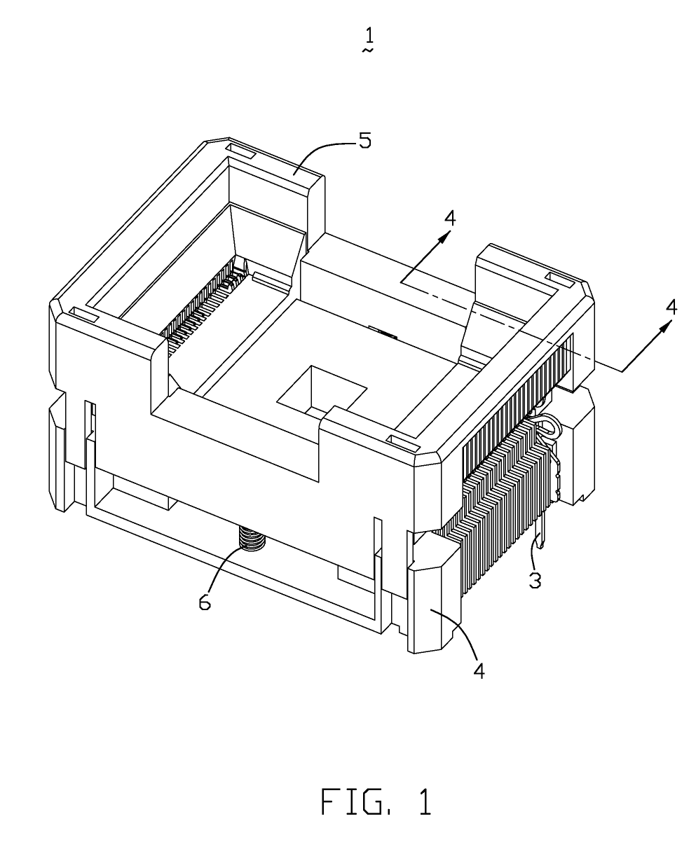

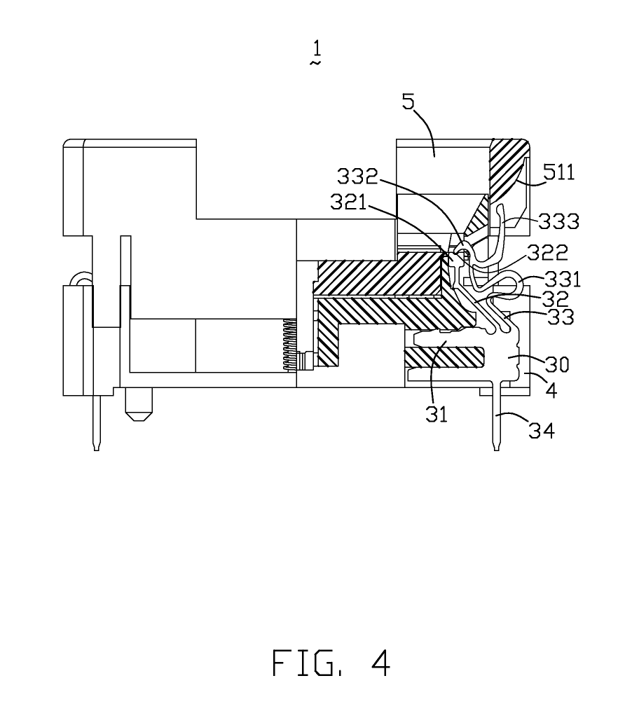

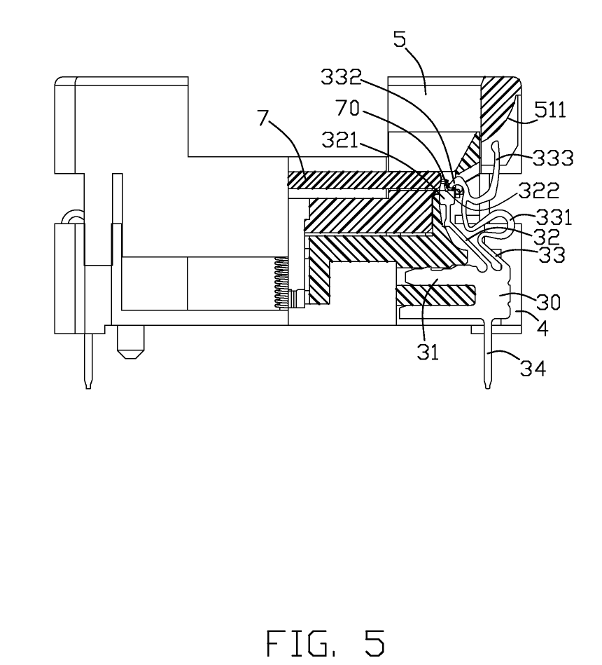

Referring to FIGS. 1-5, an IC socket 1 is mounted to a printed circuit board (not shown) for electrically connecting an IC package 7. The IC socket 1 includes a main body 4, a plurality of contacts 3 received in the main body 4, an operating cover 5 mounted upon the main body 4, and a plurality of springs 6 mounted to the main body 4.

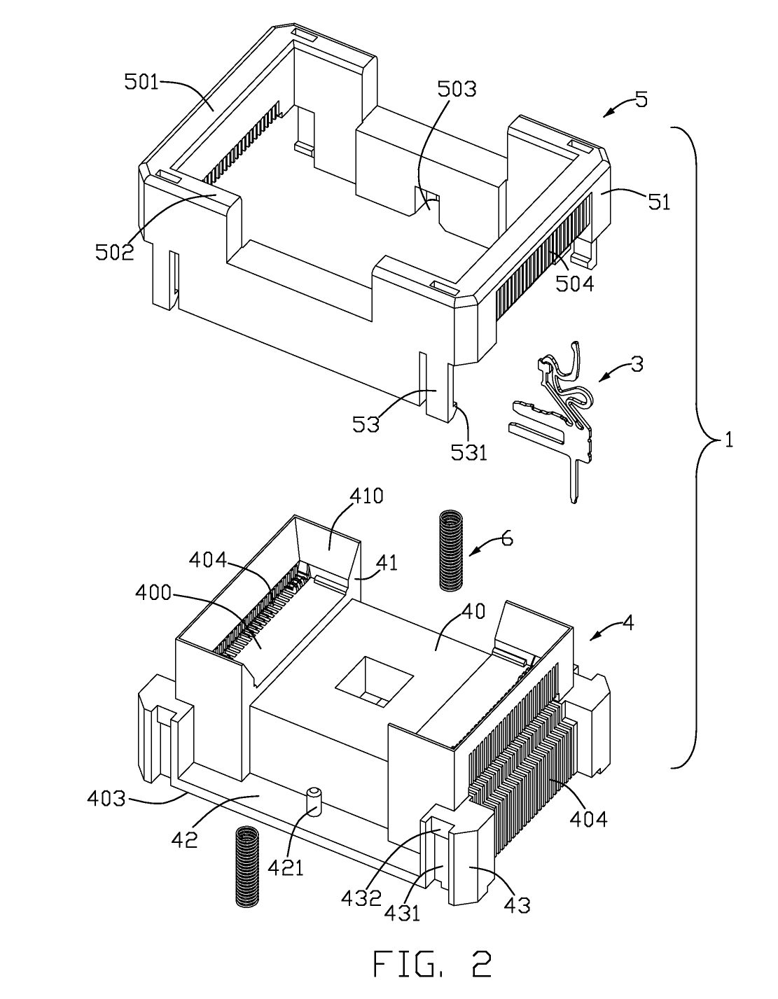

Continue to referring to FIG. 2, the main body 4 is configured with a rectangular shape, and is formed with a base 40 having periphery walls 41 extending upwardly. The base 40 includes a mating surface 400 for receiving the IC socket 7 and a mounting surface 403 opposite to the mating surface and assembled to the printed circuit board (not shown). The main body 4 defines a plurality of passageways 404 for receiving contacts 3 on opposite lateral ends thereof. The periphery walls 41 have leading-surfaces 410 adapted to lead the IC package 7 into the main body 4. The base 40 includes a plurality of flanges 43 on four corners thereof. Each of the flanges 43 provides a channel 431, which guides the operating cover 5 to move upwardly and downwardly with respect to the main body 4 and has a protrusion 432 therein for retaining the operating cover 5 to the main body 4. The main body 1 has a bottom board 42 extending outwardly from bottom portion of each of two longer opposite sides thereof. The bottom board 13 is provided with a post 421 for retaining the spring 6 thereon.

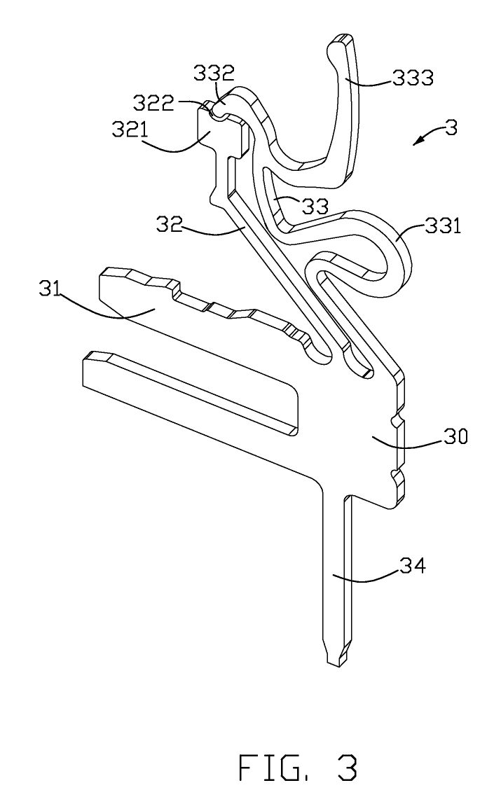

Referring to FIG. 3, each of the contacts 3 has a planar base portion 30 and a tail portion 34 extending downwardly from the base portion 30. A retaining portion 31 horizontally extends from a side of the base portion 30 to retain the contact 3 in the contact passageway 404 of the main body 4. The base portion 30 has a first contacting portion 33 and a second contacting portion 32 to clamp or engage onto a guiding track 70 of the IC package 7 to achieve electrical connection between the IC socket 1 and the IC package 7. The first contacting portion 33 has an elastic portion 331 on a middle portion thereof, the elastic portion 331 has a branch arm 333 and a first contacting end 332. The second contacting portion 32 is rectangular configured and has a second contacting end 321 formed on a free end thereof for contacting with a bottom side of the guiding track 70 of the IC package 7. The second contacting end 321 is formed with a recess 322 on a top end thereof for positioning the first contacting end 332.

The operating cover 5 is configured with a frame 51 and is formed with two short sidewalls 501 with a plurality of slots 504 corresponding to the passageways 404 of the main body 4 for accommodating the branch arm 333 of the first contacting portion 33 of the contact 3. The slot 504 has a cam surface 511 therein for pushing the branch arm 333 of the contact 3 when the operating cover 5 is pressed downwardly by an external force to separate the first contacting end 332 from the second contacting end 321. Then, upon the removal of the external force, the first contacting end 332 and the second contacting end 321 corporately clamp onto the guiding track 70 of the IC package 7, so that electrical connection between the IC socket 1 and the IC package 7 is established. The operating cover 5 has two elongate sidewalls 502 with latching portions 53 vertically and extending downwardly from four corners thereof. The latching portion 53 is formed with a claw 531 on a free end thereof, which can abut against the protrusion 432 of the main body 4 to retain the operating cover 5 on the main body 4. The elongate sidewall 502 of the operating portion 5 further defines a gap 503 corresponding to the post 421 of the main body 4 for receiving the spring 6 which provides a driving force for upwardly movement of the operating cover 5.

The IC socket 1 has at least the following advantages: when the IC package 7 is removed from the main body 4, the first contacting portion 33 returns back to an original position, the first contacting end 332 can be positioned in the recess 322 of the second contacting portion 321, that engagement can protect the contact 3 from damage or deform, and also can reduce the friction between the first contacting end 332 and the second contacting end 321 to protect plated layers thereof.

Although the present invention has been described with reference to particular embodiments, it is not to be construed as being limited thereto. Various alterations and modifications can be made to the embodiments without in any way departing from the scope or spirit of the present invention as defined in the appended claims.

What is claimed is:

1. An IC socket, comprising:
a main body defining a plurality of passageways; and
a plurality of contacts received in the passageways of the main body, each contact having a base portion, a first contacting portion and a second contacting portion extending upwardly from the base portion, the first contacting portion and the second contacting portion each formed with a contacting end facing to each other and one of the contacting end having a recess to position the other contacting end.

2. The IC socket as claimed in claim 1, wherein the base portion is formed with a tail portion extending downwardly from a bottom edge thereof and a retaining portion extending horizontally from a lateral edge thereof.

3. The IC socket as claimed in claim 1, wherein the first contacting portion has an elastic portion on a middle portion thereof, the elastic portion has a branch arm separated to the contacting end of the first contacting portion.

4. The IC socket as claimed in claim 3, wherein the contacting end of the second contacting portion is formed on a free end thereof and has a rectangular configuration, and the recess is defined on a top surface of the contacting end.

5. The IC socket as claimed in claim 4, further comprising an operating operational cover moveably mounted to the main body and is configured with a frame with a pair of elongate sidewalls and a pair of short sidewalls.

6. The IC socket as claimed in claim 5, wherein the short sidewalls defines a plurality of slots corresponding to the passageways of the main body for accommodating the branch arm of the first contacting portion of the contact.

7. The IC socket as claimed in claim 6, wherein the slot has a cam surface therein for pushing the branch arm of the contact when the operating cover is depressed downwardly to separate the contacting ends of the first and the second contacting portions.

8. An IC socket, adapted for electrically connecting an IC package to a printed circuit board, comprising:
a main body defining a plurality of passageways; and
a plurality of contacts received in the passageways of the main body, each contact having a base portion, a first contacting portion and a second contacting portion extending upwardly from the base portion, the first contacting portion and the second contacting portion each formed with a contacting end to cooperatively engage a guiding trace of the IC package, the contacting end of the second contacting portion defining a recess to interlock the contacting end of the first contacting portion when the IC package is disassembled to the main body.

9. The IC socket as claimed in claim 8, further comprising an operating cover assembled on the main body and moving vertically relative to the main body.

10. The IC socket as claimed in claim 9, wherein the operating cover is formed with a plurality of slots corresponding to the passageways of the main body and a plurality of cam surfaces in the slots.

11. The IC socket as claimed in claim 10, wherein the first contacting portion has an elastic portion on a middle portion thereof, the elastic portion has a branch arm engaging with the cam surface when the operating cover is pressed downwardly to separate the contacting ends of the first and the second contacting portions.

12. An IC socket, comprising:
a main body defining a plurality of passageways; and
a plurality of contacts received in the passageways of the main body, each contact having a base portion, a first contacting portion and a second contacting portion extending upwardly from the base portion, the first contacting portion and the second contacting portion for commonly holding a corresponding lead of an electronic package therebetween; wherein
said first contacting portion and said second contacting portion are equipped with complementary interengaging devices thereon to interlock each other when no lead of the electronic package is sandwiched between.

13. The IC socket as claimed in claim 12, wherein said complementary interengaging devices are located at free ends of said first contacting portion and said second contacting portion, respectively.

14. The IC socket as claimed in claim 13, wherein said first contacting portion and said second contacting portion each of is formed with a contacting section facing to each other for sandwiching, and one of the contacting section having a recess to position the other contacting section.
